(19) United States
(12) Patent Application Publication
(10) Pub. No.: US 2025/0250197 A1
(43) Pub. Date: Aug. 7, 2025

(54) METHOD FOR MANUFACTURING CEMENT CLINKER USING STAINLESS STEEL SLAG

(71) Applicant: ORBIX PRODUCTIONS, Genk (BE)

(72) Inventors: Serge CELIS, Gingelom (BE); Dirk VAN MECHELEN, Tisselt (BE)

(21) Appl. No.: 18/856,576

(22) PCT Filed: Apr. 14, 2023
(86) PCT No.: PCT/EP2023/059749

§ 371 Date: Oct. 11, 2024

(30) Foreign Application Priority Data
Apr. 15, 2022 (EP) 22168677.7

(51) Int. Cl. C04B 7/147; C04B 5/00

(52) U.S. Cl. CPC C04B 7/147; C04B 5/00

(57) ABSTRACT

A method for manufacturing cement clinker raw materials includes at least one stainless steel slag material that is calcined and burned to produce the cement clinker. The method further includes solidifying the liquid steel slag so that it comprises a sufficiently small amount of fines. These fines and/or the fines produced when crushing the coarser fraction of the steel slag to recover stainless steel are used as powdery stainless steel slag material for manufacturing cement clinker. These fines contain considerably less chromium than the sand and the coarser aggregate fractions produced from the solidified stainless steel slag. By replacing the conventional lime sources partially by the stainless steel slag material, carbon dioxide emissions and the energy requirements of the cement kiln can be reduced. The powdery stainless steel slag material also does not need to be finely ground and melts immediately in the rotary kiln.

### CROSS-REFERENCE TO RELATED APPLICATION(S)

This present application is a national stage application of International Patent Application No. PCT/EP2023/059579, filed Apr. 14, 2023, which claims priority to European Application No. 22168677.7, filed Apr. 15, 2022, the disclosures of which are hereby incorporated by reference in their entireties.

### TECHNICAL FIELD

The present disclosure relates to a method for manufacturing cement clinker wherein raw materials which include at least one steel slag material are calcined and burned to produce the cement clinker. The cement clinker is in particular a Portland cement clinker.

### BACKGROUND

Portland cement clinker comprises lime or calcium oxide (CaO), silica (SiO₂), alumina (Al₂O₃) and iron (Fe₂O₃). It is made starting from a raw meal produced from raw materials such as limestone, chalk, shells and shale or calcareous rock, being lime sources, sand, old bottles and clay or argillaceous rock, being silica sources, bauxite, recycled aluminium and clay, being alumina sources, and clay, iron ore, scrap iron and fly ash, being iron sources. These raw materials are crushed, milled and blended to produce a raw meal. In the dry process, the raw meal is fed in a dry state to the cement kiln whilst in the wet process a wet paste is made that is fed to the cement kiln. In the cement kiln the raw materials are heated to calcine the carbonate materials and to burn the material to produce the cement phases. These cement phases include tricalcium aluminate (Ca₃Al₂O₆ or C₃A), tetracalcium aluminoferrite (Ca₄Al₂Fe₂O₁₀ or C₄AF), belite or dicalcium silicate (Ca₂SiO₄ or C₂S) and alite or tricalcium silicate (Ca₃SiO₅ or C₃S). The cement clinker is rapidly cooled to avoid or reduce the formation of gamma-dicalcium silicate, since gamma-C₂S has no hydraulic properties, and to obtain a fine grained structure increasing the reactivity of the cement. The cement clinker is then mixed with gypsum and is finely ground. Different types of Portland cement, as defined for example in the European Standard CEN/EN 197-1, 2011, can be produced from the cement clinker by adding different cement additives.

The production of cement clinker requires a lot of energy and is a major source of carbon dioxide emissions not only as a result of the burning of fuels but also due to the release of carbon dioxide by the calcination of the carbonates contained in the raw materials. In order to reduce the energy requirements and the release of carbon dioxide, it has already been proposed to use steel slag materials as one of the raw materials. Fresh steel slags, produced at high temperatures in steel furnaces, are indeed free of carbonates. Instead of carbonates they comprise silicates. Since the calcination reaction of calcium carbonate is highly endothermal, energy can be saved, and the CO₂ emissions by burning fuel can be reduced, by replacing part of the conventional lime sources by steel slag. Moreover, no carbon dioxide is released by the steel slag during the calcination step since it is free or almost free of carbonates.

### SUMMARY

US 2004/0157181 discloses the use of a coarsely crushed steel slag material in the production of Portland cement clinker. The coarse steel slag material is introduced in the kiln not at the burning end but instead at the mid-kiln feed location in order to increase the residence time of the steel slag material in the kiln. However, due to the quite large size of the steel slag particles, feeding 10% of steel slag in the kiln resulted in a substantial variation in the amount of hydraulic tricalcium silicate and aluminate phases in the cement clinker so that blending of the ground clinker material was required to achieve a more uniform composition. A drawback of the large steel slag particles is further that they cannot be preheated in a preheater or in a precalciner. A preheater comprises indeed cyclones through which the finely ground raw meal passes before arriving into the kiln. The combustion gases leaving the kiln flow upwards, in counter current with the raw meal, through the cyclones to preheat the raw meal. The preheater often contains a zone wherein additional fuel is burnt to precalcine the calcareous raw materials. By feeding the steel slag material in the kiln at the mid-kiln feed kiln location the steel slag particles are thus heated less efficiently.

In the method disclosed in U.S. Pat. No. 6,491,751 use is also made of a granular steel slag as raw material for producing cement clinker. The coarse steel slag material is however finely ground since it will then react more readily with other elements and chemical compounds that are contained in the raw material mixture. Moreover, due to its higher ratio of surface area to volume, the finely ground steel slag is more thermally reactive when added to a kiln compared to the coarser steel slag material as received from a steel slag supplier. In order to minimize any potential for excessive wear or damage to the raw mill that may occur if only steel slag would be finely ground in the raw mill separate from the other raw materials, the coarse steel slag material is first mixed with the other raw materials to form a raw mixture that is supplied to the raw mill. A drawback of this prior art method is that the steel slag material needs to be finely ground requiring energy, time and additional milling capacity and causing additional wear to the raw mill.

In both prior art methods the steel slag that is supplied as raw material is a granular steel slag material, in particular a common steel slag material since the steel slag material is not described as being a stainless steel slag material. In U.S. Pat. No. 6,491,751 the steel slag material is moreover described as having a quite high iron content indicating that it is a common steel slag material.

The use of steel slag for producing cement is also disclosed in CN 107540250 A. This steel slag also contained a high amount of iron, namely 19.41% of Fe₂O₃. It was free of chromium so that it was clearly not a stainless steel slag. A fine fraction of the steel slag, which had a particle size of less than 0.6 mm, was added in an amount of 4 to 6.5 wt. % to the raw meal and a coarser fraction of the steel slag was added in an amount of 5 to 35 wt. % to the cement kiln. Due to its high iron content, the steel slag was used in particular to add iron oxide to the cement raw materials.

In contrast to stainless steel slags, common steel slags do not contain heavy metals such as chromium, and are therefore less problematic waste materials. The fines of common steel slags or finely ground common steel slags can be used for example as a soil conditioner whereas the fines of stainless steel slags need to be landfilled under controlled conditions. Since cement may only contain a limited amount of soluble chromium when hydrated, stainless steel slags have not been used in practice as raw material for the production of cement clinker.

The use of a stainless steel slag material for manufacturing cement clinker is however described in EP 0739318. The steel slag material described in this patent has indeed an average Cr₂O₃ content of 1.16 wt. %, which corresponds to a Cr content of 7936 mg/kg, and a low free lime content of on average only 0.5 wt. %. In order to avoid expensive fine grinding or comminution or pulverization steps, the steel slag material is only crushed to reduce its particle size to a value of less than 51 mm. The crushed steel slag is introduced in the kiln at the feed-end thereof so that it passes through the whole kiln. The steel slag is used to achieve substantial energy savings and to reduce emission of volatile materials such as carbon dioxide. The steel slags material melts indeed at a lower temperature so that no energy has to be used to grind and pulverize the steel slag. The steel slag has moreover been heat treated already in the steel furnace so that most volatile materials have already been removed.

As disclosed in EP 1055647 a coarsely crushed stainless steel slag material is however a valuable secondary material that can be used to replace natural aggregates in civil or building constructions, more particularly in concrete or asphalt. In such applications, the chromium contained in a stainless steel slag aggregate was found to be bound so that it does not causes leaching problems. Moreover, due to the low free lime content, stainless steel slags can be weathered quite easily to avoid swelling problems. Common steel slags, on the contrary, do not contain chromium but have much higher free lime contents so that they are less suitable for civil constructions.

In the examples described in EP 0739318 the stainless steel slag material was used in an amount of 5 and 10 wt. % in the raw meal for producing the cement clinker. A cement clinker with the required amounts of the cement phases C₃S, C₂S, C₃A and C₄AF could be obtained. The chemical compositions of the produced clinker materials are described in the patent but the chromium content was not mentioned. Based on the chromium content of the stainless steel slag, the addition thereof would however increase the chromium content of the cement clinker with 397 mg/kg for the 5% addition and with 794 mg/kg for the 10% addition. Most of the chromium contained in stainless steel slags is trivalent chromium that is almost not soluble in water. However, during cement processing in the kiln at temperatures between 140° and 1500° C. chromium III oxidises partially to chromium VI. The extent of chromium oxidation differs from kiln to kiln. In practice, about 15% of chromium III may for example oxidize in the kiln to chromium VI.

Hexavalent chromium is known to be carcinogenic, mutagenic and inducer of skin dermatitis. According to the EU Directive on chromates (2003/53/EC), cement may not contain more than 2 ppm of soluble chromium (VI) when hydrated. The soluble chromium is to be measured in accordance with the STN EN 196-10 standard—“Methods of testing cement”—Part 10: “Determination of the water-soluble chromium (VI) content of cement”. The correlation between the content of water-soluble chromium VI in cement and allergic reaction of the skin had already been described in the opinion of the Scientific Advisory Committee to Examine the Toxicity and Ecotoxicity of Chemical Compounds (CSTE/93/12/COM) when evaluating the safety of ferrous sulfate regarding its mutagenic potential and reproductive toxicity.

Ferrous sulfate is the most used reducing agent in cement. In practice, reduction of chromium VI in cement may be obtained by adding 0.35 wt. % of ferrous sulfate to the cement. As soon as the cement is wetted, the ferrous sulfate reduces the water soluble chromium VI to less soluble chromium III. According to Christina Laskowski in her article “Iron (II)-sulfate as concrete admixture for chromium (VI) reduction” the maximum recommended dosage of ferrous sulfate heptahydrate (FeSO₄·7H₂O) is 0.5 wt. %. By adding this amount of ferrous sulfate to cement containing 21.8 ppm of chromium VI, the amount of soluble chromium VI when hydrated was reduced to less than 0.1 ppm. The requirements for cement admixtures were moreover fulfilled although the cement properties were influenced by the ferrous sulfate. The addition of 0.5 wt. % of ferrous sulfate retarded the initial setting time of slag cement and Portland cement but accelerated the initial setting for higher strength cement classes. The final setting was retarded for all the tested cement types except for CEM I 52,5 R Portland cement.

An object of the present disclosure is to provide a new method for manufacturing cement clinker wherein use can be made of stainless steel slag as one of the raw materials, which method enables to reduce the chromium content of the cement clinker for a same amount of stainless steel slag material supplied to the cement kiln without having to use a larger amount of reducing agent.

To this end, the method according to the present disclosure is characterised in that it comprises the steps of:
providing a stainless steel slag which comprises trivalent chromium and non-metallic slag phases, which stainless steel slag has been solidified starting from a liquid stainless steel slag to produce a solidified stainless steel slag which comprises an amount of less than 70 wt. %, preferably of less than 60 wt. %, more preferably of less than 50 wt. % and most preferably of less than 40 wt. %, based on the non-metallic slag phases, of slag particles having a sieve size which is smaller than 0.5 mm and the non-metallic slag phases of which consist for at least 40 wt. % of crystalline non-metallic slag phases;
separating a powdery steel slag fraction, which has a particle size distribution with a D₉₀ sieve size value which is smaller than 0.5 mm, from the solidified stainless steel slag and/or from a granular material which has a first particle size distribution with a D₉₀ sieve size value which is larger than 5.0 mm, preferably larger than 6.0 mm and more preferably larger than 8.0 mm, and which is produced by reducing the particle size of the solidified stainless steel slag; and
using the powdery steel slag fraction as the steel slag material for producing the cement clinker.

According to the present disclosure, it has been found that the powdery steel slag fraction of the solidified stainless steel slag or of the coarsely crushed solidified stainless steel slag contains considerably less chromium than the coarser sand and aggregate fractions of the solidified stainless steel slag. When crushing and finely grinding the solidified stainless steel slag entirely into a powdery material, this powdery has a certain overall chromium content which is equal to the average chromium content of the stainless steel slag. In accordance with the present disclosure, the powdery steel slag fraction should however be separated from the stainless steel slag as solidified and/or after having reduced the particle size of the solidified stainless steel slag, for example by crushing, to produce a granular material which is still sufficiently coarse and which has in particular a D₉₀ sieve size value which is larger than 5.0 mm. By separating the powdery steel slag fraction from the stainless steel slag as solidified and/or from the coarsely crushed stainless steel slag, the powdery steel slag fraction has surprisingly a considerably smaller chromium content than the remaining coarser fraction or fractions of the stainless steel slag. This powdery stainless steel slag fraction moreover has as such already a small particle size and therefore does not have to be finely ground for use as a raw material to be fed in a cement kiln.

When solidifying the stainless steel slag, the solidified slag should be cooled sufficiently quickly in order to avoid a complete dusting of the steel slag as otherwise the fine stainless steel slag fraction would not have a reduced chromium content. The solidified stainless steel slag should contain less than 70 wt. % of slag particles which are smaller than 0.5 mm, i.e. which pass through a sieve having square 0.5 by 0.5 mm openings. This weight percentage is to be determined based on the weight of the non-metallic slag phases, i.e. not including any steel which is contained in the stainless steel slag material. Preferably the solidified stainless steel slag should contain even a smaller amount of such small stainless steel slag particles, namely less than 60 wt. %, preferably less than 50 wt. %, and more preferably less than 40 wt. %, based on the weight of the non-metallic slag phases respectively in the stainless steel slag and in the small particles.

The liquid slag has to be solidified moreover in such a manner that the non-metallic slag phases comprise at least 40 wt. % of crystalline non-metallic slag phases. The liquid slag may thus not be solidified by quenching or granulating (with water) as this would result in a mainly amorphous slag. Although this has not yet been proven, the formation of crystalline phases is thought to be essential to achieve the difference in chromium content between the powdery steel slag fraction and the coarser steel slag fractions.

The coarser fraction or fractions of the solidified stainless steel slag can be used as fine (sand) or coarse aggregates for producing concrete or asphalt wherein the chromium contained in the stainless steel slag aggregates is prevented from leaching. The powdery steel slag fraction has a smaller chromium content so that it can be used in larger amounts as raw material for manufacturing cement clinker in order to limit the carbon dioxide emissions and the energy requirements of the clinker manufacturing process. Preferably the raw materials used for manufacturing the cement clinker include at least 1 wt. % and more preferably at least 2 wt. % of the steel slag material. Due to the small particle size of the powdery stainless steel slag fraction, it can be fed at any desired location in the rotary kiln, in particular at the heat-end or at the mid-kiln feed location. In case of a wet process, the powdery slag material is preferably fed at one or more of these locations to the rotary kiln otherwise the powdery slag material would absorb quite a lot of water from the wet paste. For a dry process kiln with a preheater, it can be fed also in the rotary kiln at the mid-kiln feed location or at the heat-end, or at the feed-end, but it is preferably mixed with the raw meal or fed together with the other components of the raw meal to the preheater so that the powdery slag material is also preheated by the gases leaving the kiln.

In an embodiment of the method according to the present disclosure, it comprises the step of reducing the particle size of the solidified stainless steel slag to produce the granular material and the step of separating at least part of the powdery steel slag fraction from the granular material. Preferably, the part of the powdery steel slag fraction is separated from the granular material before any carbonation of the non-metallic slag phases contained therein or before the non-metallic slag phases contained in the part of the powdery steel slag fraction have taken up at most 3.0 wt. %, preferably at most 2.0 wt. % and more preferably at most 1.0 wt. % of carbon dioxide by carbonation of the non-metallic slag phases.

An advantage of this embodiment is that the granular material from which the powdery steel slag fraction has been removed is a valuable aggregate material for use in concrete or asphalt. Moreover, by reducing the particle size of the solidified stainless steel slag more valuable stainless steel can be recovered therefrom. At the same time, more powdery steel slag fraction is released which can be used in the method of the present disclosure as raw material for manufacturing cement clinker. The non-metallic steel slag phases contained in the granular material from which the powdery steel slag fraction is removed is preferably not carbonated or only to a small extent. This means that the non-metallic steel slag phases contained in the part of the powdery steel slag material which is separated from the granular material may have taken up at most 3.0 wt. %, preferably at most 2.0 wt. % and more preferably at most 1.0 wt. % of carbon dioxide by carbonation of the non-metallic slag phases. The uptake of carbon dioxide may have occurred before and/or after having reduced the particle size of the solidified stainless steel slag material to produce the granular material. The uptake of carbon dioxide may have occurred by reaction with carbon dioxide contained in the atmosphere, i.e. by natural weathering/aging. Carbonation is preferably to be avoided or to be limited prior to the separation of the powdery stainless steel slag fraction from the granular material since, due to carbonation, the fine steel slag particles may agglomerate to form larger particles so that the fine steel slag particles, having a lower chromium content, can no longer be separated efficiently from the coarser slag particles having a higher chromium content.

The slag particles which have a sieve size which is smaller than 0.5 mm can be left in the solidified stainless steel slag that is used in the particle size reduction step to produce the granular material. In this way, they do not need to be treated separately from the fine particles that are produced when reducing the particle size of the solidified stainless steel slag. This embodiment is especially advantageous in case the solidified stainless steel slag contains only a limited amount of the fine particles, for example less than 50 wt. % or less than 40 wt. %.

Alternatively, a part of the powdery steel slag fraction can be separated from the solidified stainless steel slag already before reducing the particle size thereof to produce the granular material. In this case, this part of the powdery steel slag fraction is preferably separated from the solidified stainless steel slag before any carbonation of the non-metallic slag phases contained therein or before the non-metallic slag phases contained in the further part of the powdery steel slag fraction have taken up at most 3.0 wt. %, preferably at most 2.0 wt. % and more preferably at most 1.0 wt. % of carbon dioxide by carbonation of the non-metallic slag phases. Also in this case carbonation is preferably to be avoided or to be limited prior to the separation of the powdery stainless steel slag fraction from the solidified stainless steel slag since, due to carbonation, the fine steel slag particles may agglomerate to form larger particles so that the fine steel slag particles, having a lower chromium content, can no longer be separated efficiently from the coarser slag particles having a higher chromium content. This embodiment wherein part of the powdery steel slag fraction is already separated from the solidified stainless steel slag is especially advantageous in case the solidified stainless steel slag contains a larger amount of the fine particles, for example more than 50 wt. % or more than 60 wt. %. They can already be removed from the solidified stainless steel slag before the solidified stainless steel slag is further crushed and subjected to sieving and steel recovery operations. More material can thus be treated with a same installation. Moreover, the powdery stainless steel slag fraction that is recovered in this way may be separated from the dry stainless steel slag so that no further drying is needed either before introducing it in the cement clinker installation or in the cement clinker installation itself.

In an embodiment of the method according to the present disclosure, or according to any one of the preceding embodiments, the particle size of the solidified stainless steel slag is reduced to produce the granular material having the first particle size distribution by crushing the solidified stainless steel slag. The granular material may in particular be produced by a crushing and sieving operation wherein the oversized particles are re-crushed.

The term crushing means to squeeze or pound into small fragments. By crushing the stainless steel slag, the size of the particles is reduced by splitting them whilst by milling steel slag the particles thereof are reduced to powder by friction. Compared to a milling operation, a crushing operation exerts less friction to the particles so that less fines are thus produced by friction in a crushing operation. The fines produced by a crushing operation are more the result of the disintegration of weaker parts of the stainless steel slag particles. It has been found that, just as the fines of the solidified stainless steel slag itself, these weaker parts contain less chromium than the stronger, larger stainless steel particles. The weaker parts may be due to the fact that they have been partially disintegrated by the transition of beta-dicalcium silicate into gamma-dicalcium silicate resulting in an expansion of the dicalcium silicate phases and a falling or dusting of the slag making the slag unusable as aggregate. The present inventors have found that this fallen fraction of the slag contains substantially less chromium than the strong aggregate fraction of the stainless steel slag and can thus be used in larger amounts in the production of cement clinker. A part of the fallen dust fraction of the stainless steel slag is already present in the stainless steel slag as solidified but a further part is produced or liberated when reducing the particle size of the solidified stainless steel slag, in particular by crushing it. A part of the powdery steel slag fraction may already be separated from the stainless steel slag as solidified and a further part from the crushed stainless steel slag or the solidified stainless steel slag can be crushed first to produce a granular material, including the fines that were already present in the stainless steel slag as solidified, before separating the powdery steel slag fraction from this granular material. Both parts of the powdery steel slag fraction are preferably not carbonated or contain, based on their non-metallic slag phases, at most 3.0 wt. %, preferably at most 2.0 wt. % and more preferably at most 1.0 wt. % of carbon dioxide in the form of carbonates. The amount of carbon dioxide can be determined by a TGA analysis wherein the powdery steel slag fraction is first heated to 110° C. to remove any water and to determine the dry weight, and wherein the powdery steel slag fraction is further heated to 550° C. to remove the hydroxides and subsequently to 950° C. to decompose the carbonates and remove the produced carbon dioxide. The percent uptake of carbon dioxide is this amount of carbon dioxide divided by the dry weight of the steel slag fraction and multiplied by hundred. Preferably, the particle size of the solidified stainless steel slag is reduced to produce the granular material by crushing the solidified stainless steel slag in at least two successive steps, with a coarser granular material being produced by the first crushing step and a portion of the granular material being removed from the coarser granular material before subjecting the coarser granular material to the second crushing step to produce a further portion of the granular material.

An advantage of this preferred embodiment is that less fines are produced, in particular less fine particles that have a higher chromium content, and also less fine aggregates (sands) that are less valuable than coarser aggregates.

Preferably, after the first crushing step a first stainless steel rich fraction is separated from the coarser granular material before removing the portion of the granular material from the coarser granular material.

Stainless steel is a valuable material that can be reused in the stainless steel production process, in particular in the EAF (Electric Arc Furnace).

In an embodiment of the method according to the present disclosure, or according to any one of the preceding embodiments, the granular material is divided by sieving into at least two different fractions, including a fine fraction, having a D₉₀ sieve size value smaller than 4 mm, preferably smaller than 3 mm or more preferably smaller than 2 mm, and a coarser fraction that is coarser than the fine fraction, at least a part of the powdery steel slag fraction being separated from the fine fraction. The coarser fraction may comprise more than 5000 mg/kg, in particular more than 5500 mg/kg and more in particular more than 6000 mg/kg of chromium.

The fine fraction comprises relatively more of the powdery steel slag fraction. When separating a sand fraction from this fine fraction the powdery steel slag fraction remains.

Preferably, a second stainless steel rich fraction is separated from the coarser fraction.

Due to the more uniform size of the particles contained in the coarser fraction, it is possible to recover additional stainless steel from this coarser fraction, in particular by gravity separation techniques such as for example by a jig.

At least a portion of the fine fraction is preferably mixed with water to produce an aqueous mixture, the aqueous mixture is separated in a sand fraction and in an aqueous dispersion, in particular by means of a dewatering classifier such as by means of a dewatering screw, and at least part of the powdery steel slag fraction is extracted from the aqueous dispersion, in particular filtered out of the aqueous dispersion. At least part of the powdery steel slag fraction is preferably filtered out of the aqueous dispersion leaving a filtrate that is stored in at least one reservoir, in that reservoir a precipitate is produced containing stainless steel slag particles, at least a portion of the precipitate being taken out of the reservoir to produce a further part of the powdery steel slag fraction.

Before the aqueous mixture is separated in the sand fraction and in the aqueous dispersion a third stainless steel rich fraction is preferably separated from the aqueous mixture by a gravity separation technique, which third stainless steel rich fraction is crushed, preferably by means of a ball mill crusher, stainless steel is recovered from the crushed third stainless steel rich fraction and remaining crushed slag material is recycled to the aqueous mixture.

Due to the more uniform size of the particles contained in the fine fraction, it is possible to recover additional stainless steel from this fine fraction, in particular by gravity separation techniques such as for example by a hydrosizer. Due to the small size of the particles in the stainless steel rich fraction, a relatively large amount of slag material still adheres to the stainless steel particles. In the present embodiment, the stainless steel particles are cleaned by subjecting them to a crushing operation, preferably by means of a ball mill crusher.

In an embodiment of the method according to the present disclosure, or according to any one of the preceding embodiments, the non-metallic slag phases of the powdery steel slag fraction contain less than 5000 mg/kg, preferably less than 4500 mg/kg and more preferably less than 4000 mg/kg of chromium. Since the powdery steel slag fraction is separated from stainless steel slag, it contains chromium, in particular more than 1000 mg/kg of chromium.

A lower chromium content enables to use a larger amount of the powdery stainless steel slag material as raw material for manufacturing cement clinker without having to add more reducing agent to the cement or it enables to add less reducing agent such as ferrous sulfate to the cement to reduce the hexavalent chromium content thereof.

In an embodiment of the method according to the present disclosure, or according to any one of the preceding embodiments, the non-metallic slag phases of the solidified stainless steel slag comprise more than 5000 mg/kg, in particular more than 5500 mg/kg and more in particular more than 6000 mg/kg of chromium.

The solidified stainless steel slag is thus a secondary material produced when manufacturing stainless steel, in particular stainless steel that contains at least 10.0 wt. % of chromium.

In an embodiment of the method according to the present disclosure, or according to any one of the preceding embodiments, the powdery steel slag fraction comprises crystalline non-metallic steel slag phases that consist for at least 3 wt. %, preferably for at least 5 wt. % and more preferably for at least 7 wt. % of gamma-dicalcium silicate (γ-C₂S or calico-olivine).

In the method according to the present disclosure the powdery steel slag fraction is not a finely ground fraction but is separated from the stainless steel slag as solidified and/or from a relatively coarse granular stainless steel slag material that is obtained by reducing the particle size of the solidified stainless steel slag. It therefore comprises a large amount of particles that have been produced by the disintegration of the steel slag as a result of the transition of β-C₂S into γ-C₂S. The powdery material has thus a higher γ-C₂S content than the coarser fractions of the steel slag. The mineralogy of the powdery material and also the basicity thereof is thus different from the mineralogy and basicity of the remaining coarser part of the stainless steel slag material that may be a possible explanation for the lower chromium content of the powdery material.

The present disclosure also relates to a method for manufacturing cement clinker wherein raw materials that include at least one steel slag material are calcined and burned to produce the cement clinker and wherein use is made, as the steel slag material, of a powdery steel slag fraction that has been obtained as defined herein above.

Since the powdery stainless steel slag fraction has been obtained by the process steps defined herein above, it has a reduced chromium content compared to the other stainless steel slag fraction or fractions. Use can thus be made of larger amounts of this powdery stainless steel slag fraction in order to limit the carbon dioxide emissions and the energy requirements of the clinker manufacturing process.

The powdery stainless steel slag fraction can be used in a freshly produced state but it can also first be stored, for example outdoors on heaps. During storage, it may be carbonated to some extent by natural carbonation. Only a limited amount of carbonates are formed in this way, which thus only have a limited effect on the carbon dioxide emissions of the cement kiln. By carbonating the powdery stainless steel slag fraction the particles thereof can be agglomerated. In the cement kiln, they however fall quickly back apart during the calcination step. It is also possible to grind the agglomerated stainless steel slag fraction that does not cause a lot of wear to the raw mill since the grains or clumps of the agglomerated stainless steel slag fraction are not hard to mill. If the powdery stainless steel slag fraction is to be added to the paste of a wet process cement kiln, it can be carbonated, preferably after being granulated into larger grains, to reduce the water uptake thereof. In this way, the water requirements of the wet paste are not increased, or to a lesser extent, by the addition of the carbonated powdery stainless steel slag fraction.

Preferably, the steel slag material is a stainless steel slag material, the non-metallic slag phases of which contain less than 5000 mg/kg, preferably less than 4500 mg/kg and more preferably less than 4000 mg/kg of chromium and which comprises crystalline non-metallic steel slag phases that consist for at least 3 wt. %, preferably for at least 5 wt. % and more preferably for at least 7 wt. % of gamma-dicalcium silicate.

The present disclosure also relates to the use of a powdery steel slag fraction that has been obtained as defined herein above as raw material for manufacturing cement clinker.

### BRIEF DESCRIPTION OF THE DRAWINGS

Other advantages and particularities of the present disclosure will become apparent from the following description of some particular embodiments of the method for manufacturing cement clinker according to the disclosure. This description is only given by way of example and is not intended to limit the scope of the disclosure. The reference numerals used in the description relate to the annexed drawings wherein:

FIG. 1 is a schematic representation of an in-line calciner kiln; and

FIGS. 2A and 2B are two parts of a flow diagram of a particular embodiment of the method for producing the powdery stainless steel slag fraction that can be used in the method according to the present disclosure to manufacture cement clinker.

### DETAILED DESCRIPTION

In the present description and claims, percent, % or wt. % refers to percent by dry weight, unless indicated otherwise.

The expression “slag phases” refers to non-metallic slag phases, which may be amorphous or crystalline. The expression “slag phases” therefore does not embrace steel phases or steel particles. Such steel particles may be embedded in the non-metallic slag phases or may consist of separate steel particles that may be coated or covered with slag phases.

The chromium content is expressed in mg Cr/kg dry weight, in particular in mg/kg by dry weight of non-metallic slag phases, unless it is explicitly indicated that it relates to the amount in Cr₂O₃. The metal phases/particles have thus been first removed from the steel slag. The amount of chromium is determined by ICP after complete destruction of the non-metallic slag phases with a mixture of the acids HNO₃, HCl and HBF₄ as described in the compendium for taking samples and for analysis of waste materials and soil samples CMA/2/II/A.3 and CMA/2/I/B.1 (both published in the Belgian Official Gazette/Moniteur belge of Jan. 11, 2021). The ICP analysis is in particular an ICP-OES analysis.

The present disclosure relates to a method for manufacturing cement clinker, in particular Portland cement clinker. After the production and cooling of the cement clinker an amount of gypsum (CaSO₄·2H₂O or CS̅H₂) is added thereto and the mixture is finely ground. The thus obtained cement clinker comprises generally 25-50 wt. % C₃S, 20-45 wt. % C₂S, 5-12 wt. % C₃A, 6-12 wt. % C₄AF and 2-10 wt. % CS̅H₂. The cement clinker mixed with gypsum preferably comprises less than 5 wt % of MgO.

After the mining, crushing, grinding and homogenisation of raw materials, the first step in cement manufacture is calcination of calcium carbonate followed by the reaction of the resulting calcium oxide together with silica, alumina, and ferrous oxide at high temperatures to form clinker. The clinker is then ground or milled together with gypsum and other constituents to produce cement. Naturally occurring calcareous deposits such as limestone, marl or chalk provide the source for calcium carbonate. Silica, iron oxide and alumina are found in various ores and minerals. Several types of wastes can also be used as partial replacements for the natural raw materials.

The cement industry is an energy intensive industry with energy typically accounting for about 40% of production costs. Various conventional fossil and waste fuels can be used to provide the thermal energy demand required for the process. Basically, characteristics of the clinker burning process itself allow the use of wastes as raw materials and/or as fuels. Clinker burning takes place in a rotary kiln that can be part of a wet or dry long kiln system, a semi-wet or semi-dry grate preheater (Lepol) kiln system, a dry suspension preheater kiln system or a preheater/precalciner kiln system.

In the method according to the present disclosure use is made of at least one powdery stainless steel slag material as one of the raw materials for manufacturing the cement clinker. In practice common steel slags such as LD slags are already used in the manufacture of cement clinker. A drawback of LD slags is however their high free lime content. The free lime in LD slags is dead burnt so that it does not dissolve or melt easily in the kiln and may thus arrive unreacted in the cement clinker. Free lime in cement clinker has to be closely monitored to ensure the quality of cement. Excess free lime results indeed in undesirable effects such as volume expansion, increased setting time or reduced strength. LD slags also need to be finely ground that increases the milling costs since slags contain silicates that have a high hardness and are hard to grind.

Compared to common steel slag, stainless steel slag has a lower free lime content. Stainless steel slag is produced in furnaces used to produce stainless steel, i.e. steel that comprises iron and at least chromium, in particular at least 10 wt. % of chromium. Often it also comprises nickel and/or molybdenum. The stainless steel slag is produced in particular in an EAF (Electric Arc Furnace), an AOD (Argon Oxygen Decarburization) furnace, a VOD (Vacuum Oxygen Decarburization) furnace, in a ladle (ladle slag) or in a tundish (used for the continuous casting of the molten steel). Due to its high heavy metal content, stainless steel slag fines are a much more problematic waste material since common steel slag fines can for example be used as soil conditioner. They can also not be used in asphalt or in concrete to their high water absorption properties. There is thus a need to find new applications that enable to use stainless steel slag fines as a secondary raw material.

In the method according to the present disclosure, the powdery stainless steel slag material is used as a secondary raw material for the manufacture cement clinker. The cement clinker is preferably produced in a dry process rotary kiln since, compared to a wet or semi-wet process kiln, a dry process kiln requires less energy, and thus also produces less carbon dioxide. The kiln is preferably provided with a preheater wherein the raw meal is heated by means of heat recycled from the kiln or from the clinker cooling section. The preheater may be a preheater/precalciner when part of the fuel is burnt in this preheater/precalciner.

In practice there are different types of cement clinker installations that comprise a precalciner unit, namely In-Line Calciners (ILC) and Separate Line Calciners (SLC). More particularly, the kiln may be a so-called pre-heater kiln, an air through calciner, an inline calciner, an inline calciner with burning chamber and an air separate calciner. Such installations are well known to the skilled person so that only as an example an in-line calciner will be described shortly hereinafter.

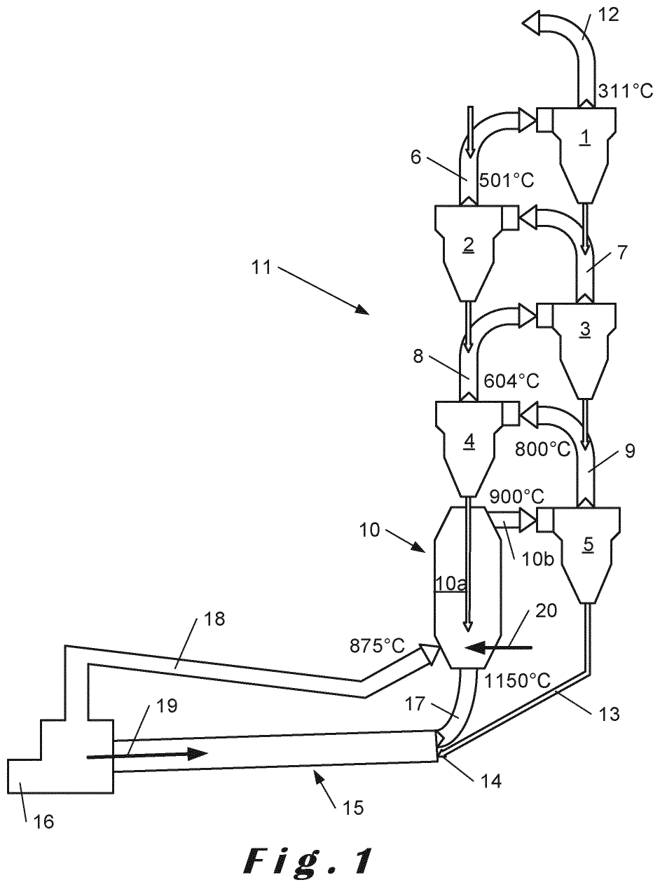

As illustrated schematically in FIG. 1, an in-line calciner comprises a number of cyclones, in this case five cyclones 1 to 5 connected by means of four riser ducts 6 to 9, and a precalciner unit 10 forming together a heat exchanging cyclone tower 11. By means of an induced draft fan (ID fan) in the exhaust pipe 12, a rising gas stream is generated in the cyclone tower 11. The raw clinker meal is normally introduced in the riser duct 6 between the second cyclone 2 and the first cyclone 1. After having passed the cyclone tower 11 the heated and at least partially calcined (decarbonated) raw clinker meal is led via a kiln feed pipe 13 to the feed end 14 of the rotating drum kiln 15. Since it has passed the precalciner unit 10, wherein a temperature in the range of 870-900° C. is generated, the degree of calcination of the material introduced in the rotating drum kiln 15 is between 90 and 95%. The material is then transported through the kiln 15 by the combination of the kiln inclination and the rotating movement thereof. At the end of the rotating drum kiln 15 a burner is provided producing a flame with air supplied through this burner in the kiln as indicated by arrow 19. As the material approaches the flame, the material temperature rises and clinkerisation occurs. Upon leaving the kiln, the material discharges onto a grate cooler 16 where it exchanges heat with secondary air so as to be cooled to produce the cement clinker.

In order to heat the precalciner unit 10, and to generate a rising gas stream therein, combustion gases produced by the combustion in the rotating drum kiln 15, i.e., kiln gas that has a temperature of about 1000° C., is guided through the kiln riser duct 17 to the bottom of the precalciner unit 10. Moreover, tertiary air, heated in the grate cooler 16 to a temperature of about 750-900° C., is also guided, by a tertiary air duct 18, to the precalciner unit 10. This tertiary air enters the pre-calciner unit 10 tangentially to create a moderate swirl ensuring an effective mixing of fuel, raw meal and gas. The temperature in the precalciner unit 10 is further controlled by means of a burner supplied with fuel and with primary air. The air for combustion of the fuel in the pre-calciner unit thus consists of kiln gas, tertiary air from the cooler and fuel conveying/atomising air supplied through the precalciner burner in the pre-calciner unit as indicated by arrow 20. About 55 to 60% of the fuel is supplied to the pre-calciner burner whilst the remaining amount of fuel is supplied to the kiln burner.

The powdery stainless steel slag fraction that is used in the method according to the present disclosure can be added to the raw meal, and can thus also be fed via the riser duct 6 into the heat exchanging cyclone tower 11. On the other hand, since it contains no or only a small amount of carbonates so that it does not need to be calcined, it can also be introduced directly into the rotary kiln 15 via the feed end 14 thereof.

In case of a wet process kiln, the raw meal is fed in the form of a wet paste at the feed end into the rotary kiln. The powdery stainless steel slag fraction can also be introduced into the rotary kiln at this feed end. Preferably, it is not added to the wet paste since the powdery stainless steel slag fraction that is used in the method according to the present disclosure has a quite high water absorption so that it would increase the amount of water required to produce the wet paste. In case of a wet process kiln, the powdery stainless steel slag fraction is preferably introduced in the kiln at the mid-kiln feed location, which is located in the calcining zone. At that location a burner is provide via that additional fuel is introduced into the kiln. The powdery stainless steel slag fraction is quickly molten at that location since it has a relatively low melting temperature. It can thus be prevented from leaving the kiln via the flow of combustion gases leaving the kiln. Alternatively or additionally, the powdery stainless steel slag fraction could also introduced in the rotary kiln at the burning end thereof, but the stainless steel slag would then have less time to react and be mixed with the other constituent elements of the cement clinker.

In the method according to the present disclosure, the powdery stainless steel slag fraction that is used as raw material to manufacture the cement clinker is produced in such a manner that it has a smaller chromium content than the steel slag from that it is made and in such a manner that it does not require additional fine grinding steps. The powdery stainless steel slag fraction is produced starting from an air-cooled stainless steel slag that comprises, apart from any stainless steel particles contained therein, crystalline steel slag phases, including chromium containing phases, and usually also amorphous steel slag phases. The powdery stainless steel slag fraction is not obtained by finely grinding the solidified stainless steel slag but is separated therefrom in such a manner that it has a particle size distribution with a D₉₀ sieve size value that is smaller than 0.5 mm.

The D₉₀ sieve size value is the particle size at 90% by volume cumulative passing. The particle size distribution can be tested according to ASTM D6913/D6913M-17 using sieves having square openings. The volume percent of the particles can in particular be calculated by dividing the weight of the particles passing through the sieve by the average density of the material forming the particles.

The air-cooled stainless steel slag is produced by pouring liquid stainless steel slag in a slag yard and by allowing it to solidify. Cooling of the solidified stainless steel slag is preferably accelerated, in particular by spraying water onto the solidified steel slag. Compared to a granulation method, such an air-cooling method results in a slower solidification of the liquid steel slag. In this way, the solidified steel slag is not entirely amorphous but comprises crystalline slag phases and usually, but not necessarily, amorphous slag phases. The non-metallic phases of the solidified stainless steel slag should comprise at least 40 wt. %, preferably at least 50 wt. % of crystalline non-metallic slag phases, i.e. mineral phases. They may also comprises amorphous non-metallic slag phases, in particular at least 20 wt. %, more particularly at least 25 wt. % of amorphous non-metallic slag phases.

Part of the powdery stainless steel material that is used to manufacture cement clinker may be separated from the stainless steel slag as solidified. The stainless steel slag as solidified contains indeed already as such an amount of particles that have a sieve size that is smaller than 0.5 mm. The particle size of the solidified stainless steel slag is preferably reduced, either after having removed these smaller particles or a portion thereof or without having removed such smaller particles from the solidified stainless steel slag, to produce a granular material having a first particle size distribution with a D₉₀ sieve size value that should still be larger than 5.0 mm.

The cooling of the steel slag should be controlled in such a manner that the amount of particles having a sieve size smaller than 0.5 mm, i.e. the amount of fines, should be less than 70 wt. %, preferably less than 60 wt. %, more preferably less than 50 wt. % and most preferably less than 40 wt. %, based on the non-metallic slag phases. The amount of non-metallic slag phases contained in these slag fines should in other words be smaller than 70 wt. % of the total amount of non-metallic slag phases in the total amount of solidified steel slag. This amount not only depends on the slag chemistry but especially also on the cooling regime of the liquid steel slag. The techniques disclosed in EP 3122909 can be applied for example to keep the amount of fines below these maximum values.

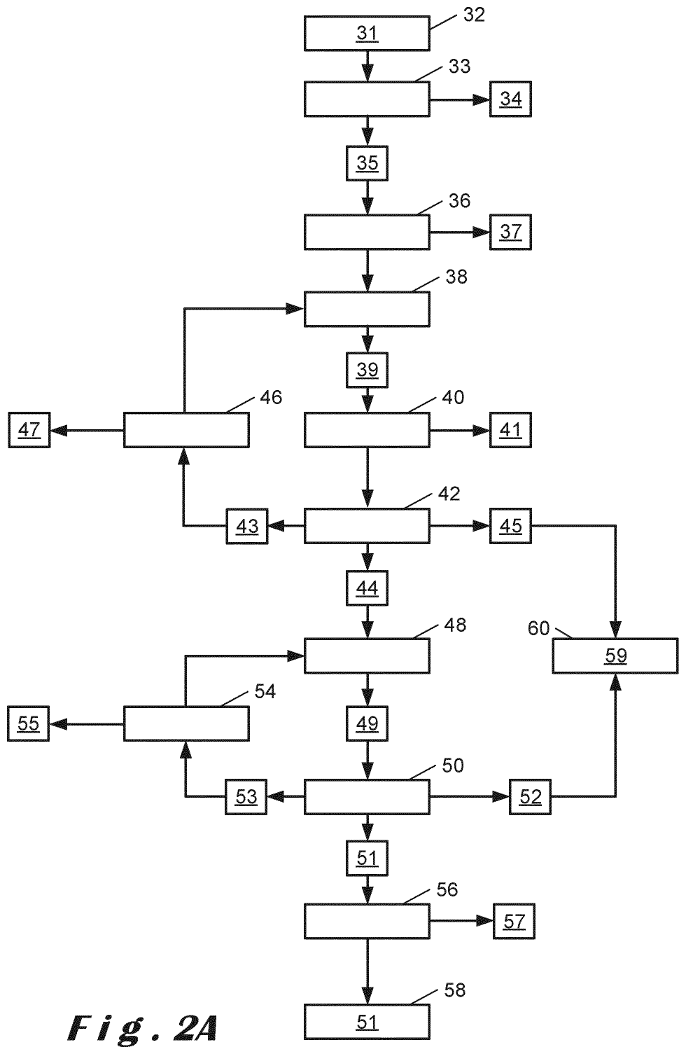

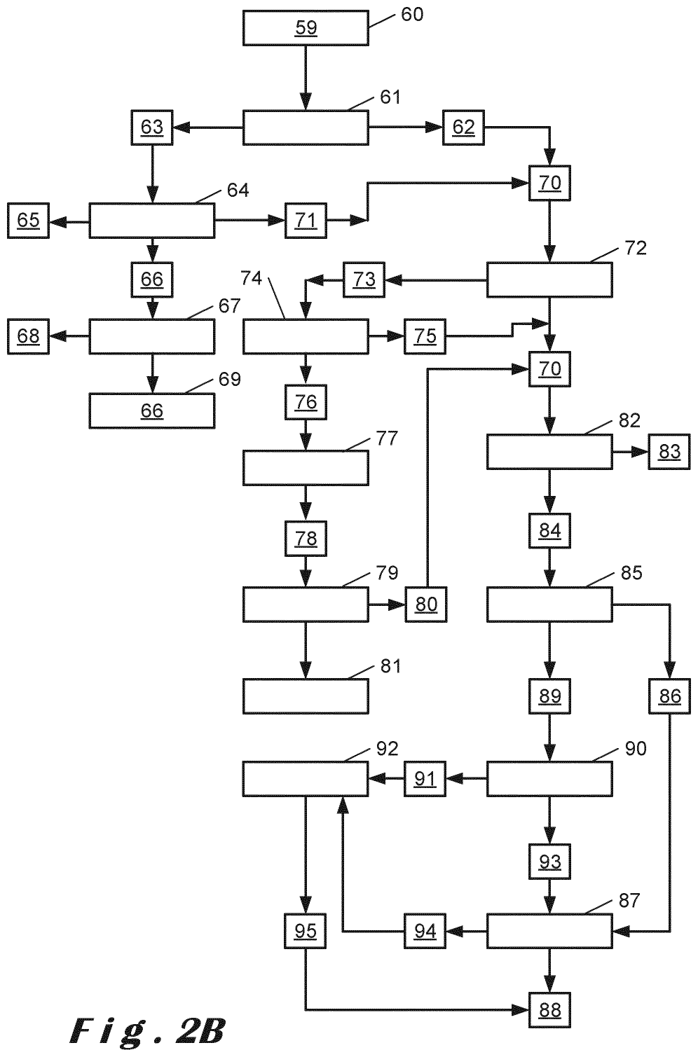

A preferred embodiment of the process for producing the powdery steel slag fraction of the stainless steel slag that can be used for manufacturing the cement clinker and that has a reduced chromium content is illustrated in FIG. 2. The liquid stainless steel slag from the different ladles and furnaces of a stainless steel production plant is poured in a slag yard into cooling pits wherein the liquid steel slag is air-cooled, i.e. left to slowly solidify and cool.

During the cooling process, water may be sprayed onto the solidified slag in order to accelerate the cooling process somewhat, especially at the end thereof. As the solidification is comparatively slow, the slag will not solidify nearly entirely in an amorphous phase but to a large extent in crystalline phases instead. One of the mineral phases of the stainless steel slag is dicalcium silicate (C₂S). As crystalline dicalcium silicate cools down, it goes through several polymorphic forms:
α with hexagonal crystal structure,
αH′ with orthorhombic crystal structure,
αL′ with orthorhombic crystal structure,
β with monoclinic crystal structure, and
γ with orthorhombic crystal structure.

With pure dicalcium silicate under laboratory conditions, the transition from αL′-dicalcium silicate to β-dicalcium silicate occurs at 675° C., then to be followed by the transition from β-dicalcium silicate to γ-dicalcium silicate at 490° C. As the transition from β-dicalcium silicate to γ-dicalcium silicate involves an increase of 12% in volume due to their different crystal structure, it will break up the dicalcium silicate phases. This pulverizes a fraction of the slag and produces the fines. The transition also causes microcracks in the pulverized particles, which appears to explain why the thus produced fines can absorb and retain large quantities of water. These water absorption properties make these fines highly unsuitable for most uses in construction. According to the present disclosure, it has however been found that these fines are suitable for use as raw material in the manufacture of cement clinker. They were indeed found to have a lower chromium content than the coarser fractions of the stainless steel slag and they do already have a small particle size so that they do not need to be finely ground. To limit the production of fines during the cooling process, the cooling process can be accelerated, in particular by spraying water onto the solidified steel slag, so that the steel slag is cooled down more quickly, in particular as from a temperature higher than 500° C., and less β-dicalcium silicate can transform into γ-dicalcium silicate.

In the process illustrated in FIG. 2, the solidified stainless steel slag 31 is stored in a slag bunker 32. The steel slag 31 is fed into a hopper 33 that comprises a grid for stopping all oversized slag pieces 34, in this particular case those bigger than 300 mm. As oversized pieces could damage the crushers used in the later process, these oversized pieces 34 are removed for later particular treatment, such as breaking with hammers and extraction of large metal fragments before being fed again through the hopper 33.

The slag particles 35 smaller than 300 mm fall through the hopper 34 onto a conveyor belt and are transported to a first metal handpicking cabin 36 wherein operators remove large metal pieces 37 from the slag particles 35 on the conveyor belt. In a next step, not illustrated in FIG. 2A, the steel slag particles 35 can be sieved to remove the fines, having a particle size that is smaller than 0.5 mm or smaller, or a portion thereof. These fines are dry or relatively dry and thus do not need to be dried before they can be fed into the cement clinker installation. The steel slag particles 35, or the remaining steel slag particles, are crushed in a first crusher 38 to produce a crushed slag material 39 that is transported along a first metal separating magnetic belt 40, removing metal particles 41 from the crushed steel slag particles 39, to a first sieve 42. The slag particles 39 then pass through the first sieve 42 that separates them into three fractions: particles 43 bigger than 35 mm, particles 44 between 10 and 35 mm and particles 45 smaller than 10 mm. The fraction of particles 43 bigger than 35 mm is taken by a second conveyor belt through a second metal handpicking cabin 46 where more metal pieces 47 are removed. The particles 43 bigger than 35 mm are then put back into the first crusher 38. The fraction of particles 44 between 10 and 35 mm goes into a second crusher 48 to produce a further crushed steel slag material 49 that is fed into a second sieve 50. The further crushed steel slag material 49 is separated in the second sieve 50 in three fractions: a fraction 51 of particles bigger than 20 mm, a fraction 52 of particles smaller than 10 mm and a fraction 53 of particles between 10 and 20 mm. The fraction 53 of particles bigger between 10 and 20 mm is taken by a third conveyor belt through a second metal separating magnetic belt 54, where more metal 55 is removed, and back into the second crusher 48. The fraction 51 with particles bigger than 20 mm is passed through a third metal separating magnetic belt 56, where more metal 57 is removed, and is stored in a box 58. This fraction 51 is a valuable coarse aggregate for use in building and road construction. The fraction 45 of particles smaller than 10 mm from the first sieve 42, and the fraction 52 of particles smaller than 10 mm from the second sieve 50 are combined to form a 0-10 mm granular material 59 that is stored in a bunker 60.

As illustrated in FIG. 2B, the granular slag material 59 is supplied to a third sieve 61, which is a 2 mm sieve separating the particles of the 0-10 mm stainless steel slag granular material 59 into a fine fraction 62 of particles smaller than 2 mm and a coarser fraction 63 of particles between 2 and 10 mm.

The coarser fraction 63 is fed into a wet jigging apparatus or jig 64, wherein metal particles 65 are removed from the coarser 2-10 mm fraction 63. The jig 64 is preferably an In Line Pressure jig as described in the article “Gravity Separation: Old Techniques New Methods” by Andrew Falconer in Physical Separation in Science and Engineering, 2003, Vol. 12, No. 1, pp. 31-48. The jig 64 is filled with water wherein the stainless steel slag particles are subjected to a jigging action so that the heavier metal particles 65 are separated by gravity from the lighter slag particles 66. The fraction 66 of lighter slag particles is passed through a fourth metal separating magnetic belt 67, where a metal rich fraction 68 is removed, and the slag particle fraction 66 is stored in a box 69. This fraction 66 is a valuable finer aggregate for use in building and road construction. The metal rich fraction 68 is finely mild to recover the metal particles contained therein. The remaining finely milled demetallized fraction is a filler fraction that can be used as a filler for example in concrete or asphalt.

The third sieve 61 is preferably a wet sieve wherein water is supplied. The fine fraction 62 is therefore mixed with water to produce an aqueous mixture 70. This aqueous mixture is also produced with water 71 from the jig 64 containing fine slag material that has been washed off from the coarser slag fraction 63.

The aqueous mixture 70 is fed into a hydrosizer 72. The working principle of the hydrosizer 72 is also described in the article “Gravity Separation: Old Techniques New Methods” by Andrew Falconer. In the hydrosizer 72 a stainless steel rich fraction 73 is separated from the aqueous mixture 70. This stainless steel rich fraction 73 is fed into a first gravity separation screw 74 from which the overflow 75 is added again to the aqueous mixture 70 whilst the underflow 76 is fed into a ball mill crusher 77 wherein slag material adhering to the stainless steel particles is removed therefrom. The crushed material 78 leaving the ball mill crusher 77 is fed into a second gravity separation screw 79. The overflow 80 of this second gravity separation screw 79 is added again to the aqueous mixture 70 whilst the underflow is a valuable fine stainless steel fraction 81.

The aqueous mixture 70, including the slag fractions 75 and 80 removed from the stainless steel rich fraction 73, is fed to a dewatering classifier, in particular a dewatering screw 82, wherein, as an underflow, a sand fraction 83 is removed from the aqueous mixture 70, in particular a 0.5-2 mm sand fraction. This sand fraction 83 can be used as fine aggregate for producing concrete or asphalt. The overflow leaving the dewatering screw 82 is an aqueous dispersion 84 of fine slag particles in water.

In order to remove the fine slag particles from the aqueous dispersion 84, this aqueous dispersion 84 is fed into a hydrocyclone 85. The working principle of the hydrosizer 72 is described in the article Gravity Separation: Old Techniques New Methods” by Andrew Falconer. The underflow 86 of the hydrocyclone 85 is filtered by means of disk filters 87 to remove the fine slag particles forming a powdery steel slag fraction 88. The overflow 89 of the hydrocyclone 85 is further treated in a thickener 90, the overflow 91 of which is pumped into a water reservoir 92 whilst the underflow 93 is treated with the disk filters 87. The further fine slag particles that are removed by means of the thickener 90 thus also arrive in the powdery steel slag fraction 88. The filtrate 94 leaving the disk filters 87 is also supplied to the reservoir 92.

The purified water contained in the reservoir 92 can be reused for supplying water to the wet sieve 61 and to the jig 64. In the reservoir 92 further fine stainless steel slag material will settle to the bottom to produce a precipitate 95. From time to time this precipitate can be removed from the reservoir 92 and can be added to the powdery stainless steel slag fraction 88.

### Experimental Data

The following experimental data show that the powdery stainless steel slag fraction 88 produced in the method described with reference to FIGS. 2A and 2B is suitable for use as raw material in the manufacture of cement clinker.

### Average Particle Size

First of all the average particle size distribution has been measured for a large number of samples of the portion of the powdery stainless steel slag fraction 88 which has been produced by the disk filters 87. The results are indicated in Table 1.

TABLE 1
Average particle size distribution, and minimum and maximum
particles size distributions, of 240 samples of the powdery
stainless steel slag fraction produced by the disk filters
87 as described with reference to FIGS. 2A and 2B.

| Sieve size | Passing | Passing | Passing |
|---|---|---|---|
| (mm) | (max vol. %) | (min vol. %) | (average vol. %) |
| 2 | 100.0 | 100.0 | 100.0 |
| 1 | 100.0 | 99.0 | 100.0 |
| 0.5 | 100.0 | 92.0 | 99.3 |
| 0.25 | 99.0 | 85.0 | 96.3 |
| 0.125 | 91.0 | 70.0 | 80.7 |
| 0.063 | 73.0 | 47.4 | 59.8 |

Based on the average particle size distribution of these samples, the D₉₀ sieve size value is equal to about 0.18 mm whilst for the sample with the smallest particle size (maximum passing), the D₉₀ sieve size value is equal to about 0.125 mm and for the sample with the largest particle size (minimum passing), the D₉₀ sieve size value is equal to about 0.4 mm. The powdery steel slag fraction 88 consists thus of small particles so that it doesn't need any further fine grinding to be readily molten in a cement kiln. Moreover, the particle size is so small that it can even be added directly to the raw meal that is fed to the preheater/precalciner in case of a dry process.

### Chemical Composition

As an example, a sample of the powdery stainless steel slag fraction 88 produced by the disk filters 87 and a sample of the precipitate 95 taken from the reservoir 92 has been analysed, by ICP after complete destruction with a mixture of acids, in particular with a combination of HNO₃, HCl and HBF₄. The following results were obtained:

TABLE 2
Elemental analysis, in mg of the element/kg dry weight and
in wt. % oxide, of a sample of the powdery stainless steel
slag fraction 88 from the disk filters 87 and of a sample
of the precipitate produced in the reservoir 92.

| | Powdery steel slag | | | |
|---|---|---|---|---|
| | fraction produced | | Precipitate collected | |
| | by the disk filters | | from the reservoir | |
| | mg/kg | wt. % | mg/kg | wt. % |
| | DW | oxide form | DW | oxide form |
| Calcium (CaO) | 374000 | 52.3 | 337000 | 47.2 |
| Silicon (SiO₂) | 77300 | 16.6 | 107000 | 22.9 |
| Magnesium (MgO) | 54100 | 9.0 | 47100 | 7.9 |
| Aluminium (Al₂O₃) | 25600 | 4.7 | 20700 | 3.9 |
| Chromium (Cr₂O₃) | 2430 | 0.35 | 1980 | 0.29 |

The powdery steel slag fraction produced by the disk filter moreover contained, in mg/kg dry weight: <120 Br, 17200 F, 220 Cl, <200 K, 2560 Na, 6090 Ti, 15 Cu, 245 Ni, 17 Zn, 215 Ba, 9.8 Co, 8980 Mn, 60.2 Mo, 11.2 Se, 152 V, 1860 S and 1380 B. The precipitate moreover contained <110 Br, 15000 F, 310 Cl, 370 K, 4440 Na, 5010 Ti, 15 Cu, 161 Ni, 26 Zn, 236 Ba, 7.3 Co, 5820 Mn, 38.4 Mo, <10.0 Se, 119 V and 1710 S.

It can be seen that both materials have a high calcium and silicon content and that the ratio of calcium to silicon is similar to the calcium/silicon ratio in cement clinker. Aluminium is also an element that is required in cement clinker. Chromium is not desired and the amount of soluble chromium after hydration of the cement produced from the cement clinker has to remain below 2 ppm. This can be achieved by limiting the amount of the powdery stainless steel slag fraction that is used as raw material for the production of the cement clinker and also by adding a sufficient amount of reducing agent to the cement. Non limitative examples of suitable reducing agents include ferrous sulfate (FeSO₄), in particular ferrous sulfate heptahydrate (FeSO·7H₂O), stannous chloride (SnCI₂), stannous sulfate (SnSO₄), stannous oxide (SnO), stannous hydroxide (Sn(OH)₂), stannous manganese sulfate, iron sulphide (FeS), and/or ferrous chloride (FeCI₂), in particular ferrous chloride tetrahydrate (FeCI₂·4H₂O) and combinations thereof. Preferred reducing agents are FeSO₄·7H₂O, SnSO₄, SnCI₂, SnO, Sn(OH)₂ and combinations thereof.

When not stored/aged, the powdery steel slag fraction collected by the disk filters and put on a pile contains only a limited amount of carbonates. Over a period of one year, the carbonate content of this fresh powdery steel slag fraction has been measured by TGA. On average, the fresh powdery steel slag fraction contained 1.6 wt. % of CO₂, with a maximum value of 2.5 wt. % and a minimum value of 0.4 wt. %. These carbonates are formed during the processing of the stainless steel slag but a portion of them are formed after having separated the powdery steel slag fraction from the granular steel slag material. The precipitate collected from the reservoir was found to contain more carbonates. The water used in the installation is indeed highly alkaline by the contact with the stainless steel slag particles and will thus absorb quite easily carbon dioxide from the atmosphere. This carbon dioxide was found to precipitate in the form of fine calcium carbonate particles, which are thus also contained, in addition to the stainless steel slag particles, in the precipitate 95 collected from the water reservoir 92. For a number of samples, the CO₂ release has been measured by a TGA analyses. The amounts varied between 3 and 7 wt. % CO₂, corresponding to calcium carbonate contents varying between about 7 to about 16 wt. %. Only about 4 to 9 wt. % of the CaO is bound in these carbonates so that most of the CaO is still contained in other compounds, such as silicates, which do not release CO₂ when used for the manufacture of cement clinker.

The maximum amount that can be used of these powdery steel slag fractions as raw material for producing cement clinker is limited by the MgO content. In cement clinker, the MgO content should indeed be lower than 5 wt. %. However, the maximum amount would then still be about 30 wt. %. At such amounts, the other parameters of cement clinker, such as NazO_{eq}, Cl, SO₃ and DoS (degree of sulfation), are not limiting. The only limiting parameter would be the chromium content.

### Reduction of the Chromium Content

Over a period of ten years, powdery stainless steel slag fraction 88 has been produced by the method as described herein above with reference to FIGS. 2A and 2B. During that period, the precipitate 95 formed in the reservoir was however not collected and was thus not added to the powdery steel slag fraction 88.

The liquid stainless steel slag used to produce the solidified stainless steel slag originated from the EAF and the AOD of a stainless steel production plant. The liquid slag was slowly solidified and was then cooled more quickly by spraying water over the solidified steel slag. In this way, the production of fines in the slag pits was limited. These fines were also treated by the method as illustrated in FIGS. 2A and 2B and thus arrived in the powdery stainless steel slag fraction 88. On average, this powdery stainless steel slag fraction 88 was about 30% of the total amount of the coarse and the finer aggregate fractions 51 and 66, of the sand fraction 83 and of the powdery stainless steel slag fraction 88. The amount of fines produced in the slag pits was not measured, but can be estimated at about 70% of the amount of the powdery stainless steel slag fraction 88, i.e. to about 20% of the total amount of non-metallic slag phases contained in the solidified stainless steel slag 31.

The steel slag fractions were stored in boxes on heaps. The 2-10 mm fraction 66 was sieved in two fractions, namely in a 2-6 mm aggregate fraction and a 6-10 mm aggregate fraction. Table 3 gives the results of the different analyses of the chromium content in the different fractions produced over a period of ten years. The analyses were done in the different production years shortly after the production of the different slag fractions. The results thus cover the production of stainless steel slag over a period of ten years. During these years, different types of stainless steel have been produced by the steel mill. Moreover, the slags were produced in different furnaces, in particular in EAF and in AOD furnaces.

TABLE 3
Chromium content, in mg Cr/kg dry weight in the different
powdery, sand and aggregate fractions produced by the
method as described herein above with reference to
FIGS. 2A and 2B over a period of ten years.

| | 0-0.5 mm | 0.5-2 mm | 2-6 mm | 6-10 mm |
|---|---|---|---|---|
| 1 | 3600 | 4800 | 5700 | 4600 |
| 2 | 1600 | 3300 | 3200 | 5279 |
| 3 | 3900 | 8360 | 4140 | 7930 |
| 4 | 3603 | 8788 | 6068 | 7408 |
| 5 | 3910 | 5520 | 5660 | 4780 |
| 6 | 3620 | 6920 | 10400 | 7880 |
| 7 | 3040 | 7130 | 5650 | 8730 |
| 8 | 3100 | 6210 | 11200 | 7360 |
| 9 | 2850 | 5800 | 8230 | 6080 |
| 10 | 2550 | 6900 | 4010 | 4310 |
| Average | 3177 | 6373 | 6426 | 6436 |

According to these analysis results, the fine (sand) and coarser aggregate fractions of the stainless steel slag have, on average, all about a same chromium content whilst the powdery (0-0.5 mm) fraction has, on average, a much smaller chromium content, namely a chromium content that is only about halve of the chromium content of the aggregate fractions. Since the chromium content of stainless steel slag appears to be the limiting factor for the use of stainless steel slag as raw material for the manufacture of cement clinker, using the powdery stainless steel slag fraction instead of the aggregate fraction enables to use about twice as much of stainless steel slag. Moreover, the powdery stainless steel slag fraction melts more quickly in the cement kiln and needs no fine grinding for being suitable to be fed to the preheater/precalciner.

A number of the stainless steel slag fractions collected over the years have also been analysed by XRD to analyse the crystalline phases thereof. On average, the different stainless steel slag fractions contained about 35 wt. % of amorphous slag phases and about 65 wt. % of crystalline phases. Although some of the powdery stainless steel slag fractions had a somewhat higher content of amorphous phases, which would contain less chromium, this cannot explain the much lower chromium content of the powdery steel slag fractions.

The XRD results showed however a big difference in olivine (γ-dicalcium silicate) content. For the powdery stainless steel slag fractions the γ-C₂S content varied between 6.2 and 16.5% of the crystalline slag phases, with an average of 11.3%. For the aggregate fractions, the γ-C₂S content varied between 1.6 and 3.4% of the crystalline slag phases, with an average of 2.6%. Although chromium does not accumulate in dicalcium silicate the γ-C₂S content may be an indication of the basicity of the steel slag. Indeed, the higher the basicity of a steel slag, the higher the tendency to form γ-C₂S. In general, chromium is present in stainless steel slag in the spinel phases, namely in MgO(Al₂O₃, Fe₂O₃, Cr₂O₃) phases. These spinel phases might contain more chromium when the basicity of the steel slag is lower. This might be one of the reasons why the powdery stainless steel slag fraction has a considerably lower chromium content than the aggregate fractions.

### Magnesiochromite Contents Determined by XRD

Magnesiochromite is a spinel phase having a high chromium content. Most of the chromium in stainless steel slag is contained in this magnesiochromite phase. Over a period of one year, the magnesiochromite content of the freshly produced powdery steel slag fraction 88 has been analyzed about twice a week. In total, 120 samples have been analyzed. The average magnesiochromite content was equal to 3.21% of the crystalline slag phases, the minimum was equal to 1.1% and the maximum was equal to 5.4%.

Eight samples of the demetallized filler fraction obtained by finely milling and demetallizing the metal rich fraction 68 were also analyzed by XRD. The average magnesiochromite content of these samples was equal to 10.00% of the crystalline slag phases, the minimum was equal to 9.2% and the maximum was equal to 12.1%. The magnesiochromite content of this finely milled and demetallized 2-10 mm slag fraction was thus more than 3 times higher than the magnesiochromite content of the powdery steel slag fractions 88.

As to the γ-C₂S content, the powdery stainless steel slag fractions 88 again had a much higher γ-C₂S content than the demetallized filler fraction, namely on average 8.01% versus 1.17% for the filler fraction.

### Estimated Cr(VI) Content Cement Clinker Composition

The powdery stainless steel slag fraction is free or substantially free of hexavalent chromium, i.e. Cr(VI). During the clinkerisation process at high temperatures part of the Cr(III) present in the powdery stainless steel slag fraction is however transformed into Cr(VI). The degree of oxidation depends from the cement kiln and the calcination/clinkerisation process. It depends for example from the gasses present in the kiln, in particular from the oxygen content thereof.

In the article “Removal of soluble Cr(VI) in Cements by Ferrous Sulfate Monohydrate, solid lignin and other Materials” by Emin Erdem et al. in Ceramisc Slikaty, March 2011, three different cement types are tested, namely CEM I 42.5R, containing 190.4 mg/kg of total Cr, CEM II/A-P 42.5N, containing 125.2 mg/kg of total Cr, and CEM IV/B (P) 32.5N, containing 56.3 mg/kg of total Cr. The total chromium embraces both Cr(III) and Cr(VI). The soluble chromium, i.e. Cr(VI), measured in accordance with the STN EN 196-10 standard, should be lower than 2 ppm. For the three types of cement this soluble chromium content was respectively 17, 11 and 4.5 ppm. To reduce the soluble chromium content to 2 ppm, respectively 0.16 wt. %, 0.08 wt. % and 0.04 wt. % of ferrous sulfate heptahydrate needed to be added. These amounts are substantially directly proportional with the amounts of total chromium present in the cement.

Adding 5 wt. % of the powdery stainless steel slag fraction having a total Cr content of 3000 ppm, would increase the Cr content of the cement with about 150 ppm. The Cr content of the CEM I 42.5R cement would thus almost double so that the soluble chromium content, and the required amount of reducing agent would also almost double. It can thus be estimated that a total amount of about 0.30 wt. % of ferrous sulfate heptahydrate would be sufficient to keep the soluble Cr(VI) content, as determined in accordance with STN EN 196-10, below 2 ppm. This amount is well below the maximum recommended dose of 0.5 wt. % as mentioned by Christina Laskowski in her publication referred to herein above.

It can be calculated that by replacing 5% of the calcium carbonate in the raw clinker meal by the powdery stainless steel slag fraction, a reduction of the carbon dioxide emissions caused by the calcination of about 6 to 7.5%, depending on the composition of the raw meal, can be achieved. Moreover, about 5% of energy can be saved, with an additional reduction of the carbon dioxide emissions generated by the fuel.

Higher amounts of the powdery stainless steel slag are also possible, either by adding a higher amount of the reducing agent or for example by selecting the origin of the stainless steel slag. Some stainless steel types contain for example only about 12% chromium whilst others contain 17 to 18% chromium so that the slag floating on top of the molten stainless steel will also contain less chromium. The chromium content of the stainless steel slag can also be reduced, for example by adding metallic aluminium to the liquid slag floating on the liquid steel that will reduce the chromium chemically and decrease the chromium content of the slag. As described in EP 3901289 adding aluminium in the stainless steel furnace may also reduce the formation of fines in the solidified steel slag. Moreover, a higher amount of aluminium in the powdery stainless steel fraction increases the value of this fraction as raw material for the cement clinker production as cement clinker also has to contain alumina.

1. A method for manufacturing cement clinker wherein raw materials which include at least one steel slag material are calcined and burned to produce the cement clinker, which method comprises the steps of:
providing a stainless steel slag which comprises trivalent chromium and non-metallic slag phases, which stainless steel slag has been solidified starting from a liquid stainless steel slag to produce a solidified stainless steel slag which comprises an amount of less than 70 wt. %, based on the non-metallic slag phases, of slag particles having a sieve size which is smaller than 0.5 mm and the non-metallic slag phases of which consist for at least 40 wt. % of crystalline non-metallic slag phases;
separating a powdery steel slag fraction, which has a particle size distribution with a D₉₀ sieve size value which is smaller than 0.5 mm, from the solidified stainless steel slag and/or from a granular material which has a first particle size distribution with a D₉₀ sieve size value which is larger than 5.0 mm and which is produced by reducing the particle size of the solidified stainless steel slag; and
using the powdery steel slag fraction as the steel slag material for producing the cement clinker.

2. The method according to claim 1, wherein it comprises the step of reducing the particle size of the solidified stainless steel slag to produce the granular material and the step of separating at least part of the powdery steel slag fraction from the granular material.

3. The method according to claim 2, wherein the part of the powdery steel slag fraction is separated from the granular material before any carbonation of the non-metallic slag phases contained therein or before the non-metallic slag phases contained in the part of the powdery steel slag fraction have taken up at most 3.0 wt. %, preferably at most 2.0 wt. % and more preferably at most 1.0 wt. % of carbon dioxide by carbonation of the non-metallic slag phases.

4. The method according to claim 2, wherein the slag particles which have a sieve size which is smaller than 0.5 mm are left in the solidified stainless steel slag which is used in the particle size reduction step to produce the granular material.

5. The method according to claim 2, wherein a further part of the powdery steel slag fraction is separated from the solidified stainless steel slag before reducing the particle size thereof to produce the granular material, in particular before any carbonation of the non-metallic slag phases contained therein or before the non-metallic slag phases contained in the further part of the powdery steel slag fraction have taken up at most 3.0 wt. %, preferably at most 2.0 wt. % and more preferably at most 1.0 wt. % of carbon dioxide by carbonation of the non-metallic slag phases.

6. The method according to claim 2, wherein the particle size of the solidified stainless steel slag is reduced to produce the granular material having the first particle size distribution by crushing the solidified stainless steel slag.

7. The method according to claim 6, wherein the particle size of the solidified stainless steel slag is reduced to produce the granular material by crushing the solidified stainless steel slag in at least two successive steps, with a coarser granular material being produced by the first crushing step and a portion of the granular material being removed from the coarser granular material before subjecting the coarser granular material to the second crushing step to produce a further portion of the granular material.

8. The method according to claim 7, wherein after the first crushing step a first stainless steel rich fraction is separated from the coarser granular material before removing the portion of the granular material from the coarser granular material.

9. The method according to claim 2, wherein the granular material is divided by sieving into at least two different fractions, including a fine fraction, having a D₉₀ sieve size value smaller than 4 mm, and a coarser fraction which is coarser than the fine fraction, at least a part of the powdery steel slag fraction being separated from the fine fraction.

10. The method according to claim 8, wherein a second stainless steel rich fraction is separated from a coarser fraction.

11. The method according to claim 8, wherein at least a part of a fine fraction is mixed with water to produce an aqueous mixture, the aqueous mixture is separated in a sand fraction and in an aqueous dispersion, in particular by means of a dewatering classifier, and at least part of the powdery steel slag fraction is extracted from the aqueous dispersion.

12. The method according to claim 11, wherein a third stainless steel rich fraction is separated from the aqueous mixture by a gravity separation technique before the aqueous mixture is separated in the sand fraction (83) and in the aqueous dispersion, which third stainless steel rich fraction is crushed, preferably by means of a ball mill crusher, stainless steel is recovered from the crushed third stainless steel rich fraction and remaining crushed slag material is recycled to the aqueous mixture.

13. The method according to claim 11, wherein at least part of the powdery steel slag fraction is filtered out of the aqueous dispersion leaving a filtrate which is stored in at least one reservoir, in which reservoir a precipitate is produced containing stainless steel slag particles, at least a portion of the precipitate being taken out of the reservoir to produce a further part of the powdery steel slag fraction.

14. The method according to claim 1, wherein the non-metallic slag phases of the powdery steel slag fraction contain less than 5000 mg/kg, preferably less than 4500 mg/kg and more preferably less than 4000 mg/kg of chromium.

15. The method according to claim 1, wherein the non-metallic slag phases of the solidified stainless steel slag comprise more than 5000 mg/kg, in particular more than 5500 mg/kg and more in particular more than 6000 mg/kg of chromium.

16. The method according to claim 1, wherein the powdery steel slag fraction comprises crystalline non-metallic steel slag phases which consist for at least 3 wt. %, preferably for at least 5 wt. % and more preferably for at least 7 wt. % of gamma-dicalcium silicate.

17. The method according to claim 1, wherein the raw materials comprise at least 1 wt. %, preferably at least 2 wt. of the steel slag material.

18. The method according to claim 1, wherein at least part of the powdery steel slag fraction is separated from the solidified stainless steel slag before any carbonation of the non-metallic slag phases contained therein or before the non-metallic slag phases contained in the part of the powdery steel slag fraction have taken up at most 3.0 wt. %, preferably at most 2.0 wt. % and more preferably at most 1.0 wt. % of carbon dioxide by carbonation of the non-metallic slag phases.

19. A method for manufacturing cement clinker wherein raw materials which include at least one steel slag material are calcined and burned to produce the cement clinker and wherein use is made, as the steel slag material, of a powdery steel slag fraction which has been obtained according to claim 1.

20. A use of a powdery steel slag fraction which has been obtained according to claim 1 as raw material for manufacturing cement clinker.

21. The method according to claim 19, wherein the steel slag material is a stainless steel slag material which contains less than 5000 mg/kg, preferably less than 4500 mg/kg and more preferably less than 4000 mg/kg of chromium and which comprises crystalline non-metallic steel slag phases which consist for at least 3 wt. %, preferably for at least 5 wt. % and more preferably for at least 7 wt. % of gamma-dicalcium silicate.
